(19) United States
(12) Patent Application Publication
(10) Pub. No.: US 2026/0257700 A1
(43) Pub. Date: Sep. 3, 2026

(54) CONVEYING FACILITY WITH A CONVEYING UNIT FOR THE SUSPENDED TRANSPORT OF TRANSPORT ELEMENTS FOR DIFFERENT TYPES OF CONVEYED ITEMS

(71) Applicant: Ferag AG, Hinwil (CH)

(72) Inventor: Roberto Fenile, Hinwil (CH)

(21) Appl. No.: 19/551,743

(22) Filed: Feb. 27, 2026

(30) Foreign Application Priority Data
Feb. 28, 2025 (CH) 000197/2025
Sep. 10, 2025 (CH) 001050/2025
Dec. 1, 2025 (CH) 001396/2025

(51) Int. Cl. B61B 3/00; B65G 65/00

(52) U.S. Cl. CPC B61B 3/00; B65G 65/00; B65G 2814/0301

(57) ABSTRACT

Conveying units for the suspended transport of conveyed items in a conveying facility such as a rail-led conveying facility with a conveying element and an attached carrier hook, and with a transport element. The transport element has a frame structure and a suspension hook that is attached to the frame structure. The suspension hook is mounted in the carrier hook of the conveying element in a suspended manner. The transport elements can be formed as differently designed transport pockets and the transports pockets in the conveying direction each have a leading and a trailing pocket wall that are connected to one another via a pocket base section so as to form a receiving space in which the conveyed items can be conveyed. The differently designed transport pockets for the unloading and loading of the conveyed items are each fed to a pocket-specific unloading device and loading device, respectively.

The present invention relates to the field of transport and conveying technology. It concerns a conveying facility with a plurality of conveying units for the suspended transport of transport elements, in particular of different transport pockets, for the conveying of different types of conveyed items, according to the preambles of claims 1 and 15.

### TECHNOLOGICAL BACKGROUND

In automated warehouses, vast production facilities and very generally concerning the conveying and transport of goods, suspended conveying systems have been proven to be an efficient means for the transport, the intermediate buffering, but also the long-term storage of different types of goods. Regarding suspended conveying systems, in a suitable manner the goods are either suspended directly on individual conveying elements of a conveying system, for example coat hangers with pieces of clothing which are suspended thereon, or are brought into suitable transport elements such as for example transport pockets, which in turn are mounted on the conveying elements in a suspended manner. Conveying facilities which each use one type of transport element in the form of transport pockets in this conveying facility are known from the state of the art. Hence all conveyed items are conveyed in this type of conveying element. Since the conveyed items are very heterogenic, the conveying elements in the form of conveying pockets are often too large for a share of the conveyed items, and this entails a sub-optimal utilisation of the conveying volume. On the other hand, it is precisely in automated conveying facilities that different conveying elements in the form of conveying pockets also require different loading stations and different unloading stations for the respective conveying elements.

Likewise known are gravity-assisted conveying systems, concerning which individual conveying elements which are provided with wheels move on corresponding runner rails. One example of such a gravity-assisted, rail-led conveying system is known from WO 2016/030275 A1 of the applicant.

Suspended conveying systems with transport elements are particularly suited for the efficient conveying of heterogenic individual item goods such as for example workpieces in production processes, cosmetic articles, spare parts, consumer goods such as books, pieces of clothing, shoes, etc.

Hence for example suspended conveying systems can be used in logistics centres of mail order companies, in order to store a multitude of articles of a different size and weight and to order pick groups of articles according to the respective customer orders and to prepare them for shipping.

Herein, an aspect which is relevant to a suspended conveying system is the simple, smooth-running and efficient bringing of goods into empty transport elements and the unloading of the goods from the transport elements.

A manual filling of provided, empty transport elements such as for example transport pockets permits a flexible, gentle handling of different goods, but is slow and cost-intensive.

It is thus known from the state of the art to apply suspended conveying devices with conveying pockets for the transport of goods or articles, hereinafter called conveyed items for simplicity.

The publication documents DE 102004018569 A1 and U.S. Pat. No. 11,465,847 B2 for example describe a suspended conveying device with a plurality of conveying or collection pockets which can be folded together, for receiving and for the sorting collecting of objects, in particular pieces of clothing. The collection pocket comprises a pivotable frame mount and a pocket pouch which is suspended on the frame mount. The collection pocket is suspended on the suspended conveying device or on a runner vehicle via a hook connection element which is attached to the frame mount.

The advantage of conveying pockets lies in the fact that these are designed in a foldable manner. By way of this, the receiving compartment can be compressed by way of folding together. In this manner, the conveying pockets permit space-saving logistics of goods, which is in contrast to rigid boxes and containers. Empty conveying pockets with a compressed receiving compartment can thus be stored or conveyed in a space-saving manner. The receiving compartments do not need to be expanded to the extent that they take up space, until the transport or storage of the goods.

EP 2418160 B1 shows another loading station for transport pockets which are transported in a suspended conveying facility. The transport pockets comprise a frame bow which is suspended on a conveying element and on which two ends of a flexible material web are fastened and form a pouch. A pressure plate is arranged below the suspension hook of the pouch. A skid is arranged in the loading station, said skid on movement of transport pocket through the loading station pressing the pressure plate and thus also the transport pocket from an orientation transverse to the conveying direction into an orientation parallel to the conveying direction and holding it in this orientation over the course of the skid. The shape of the suspension hook is selected such that herein this is pressed upwards in the carrier hook of the conveying element away from a minimum of the potential energy. At the same time, the frame bow is also pressed outwards perpendicularly to the conveying direction and assumes a position in which the pouch is open to the top. In this position, the transport pocket can be filled from the side through the upper opening. After leaving the region of the skid, the suspension hook slides on the carrier hook back again to the minimum of potential energy and the pocket pivots back into an orientation transverse to the conveying direction.

The publication document CH 720950 A1 describes a conveying pocket for a suspended conveying facility for the suspended conveying of a conveyed item along a conveying track, wherein the conveying pocket considered in the conveying direction comprises a front pocket wall and a rear pocket wall which trails the front pocket wall, said pocket walls being connected to one another by a pocket base, and the front and rear pocket wall together with the pocket base delimit a main receiving compartment which is open to the top through a pocket opening. The conveying pocket further comprises a holding device for the clamping receiving of an extensive conveyed item on the outer side of at least one of the pocket walls, in particular the rear wall.

DE 102004018569 B4 shows a further device for loading transport pockets in a suspended conveying facility. The transport pockets comprise a frame bow which is suspended on a conveying element transversely to the conveying direction and which defines an upper opening of the pocket. A flexible material web which is fastened to the frame bow at two ends forms a pouch for receiving individual item elements. Side walls only close a lower part of the sides of the pouch, so that lateral insert openings remain. On moving the transport pockets along the conveying path through the device, suitably designed slotted guides move the frame bow which is suspended in a perpendicular manner in the empty state of the transport pocket into a horizontal position in which the lateral insert openings are maximally opened. The articles can now be manually inserted into the pocket through the lateral openings. An automatic filling is not possible since the upper openings of the pockets are not accessible due to the runner rail of the conveying system.

WO 2018142242 A1 shows a conveying unit for the suspended transport of transport elements in a conveying system, in particular in a rail-led conveying system or in a conveying chain system. The conveying system comprises a carrier hook which is attached to a conveying element, in particular to a runner vehicle or a conveying chain link, and further comprises a transport element and a suspension hook which is attached to the transport element, wherein the suspension hook is mounted in the carrier hook in a suspended manner. The carrier hook is designed in a manner such that the suspension hook can assume two stable positions in the carrier hook. The suspension hook in a first stable position is rotated by an angle with respect to the suspension hook in a second stable position. The conveying system is designed with active arrangements for the active rotation of the transport pocket.

Modern transport elements such as for example transport pockets in suspended conveying facilities can comprise several receiving spaces for conveyed items. The several receiving spaces can be designed differently, depending on which conveyed item is to be conveyed. Given the lateral filling of the transport pockets with conveyed items from above, there arises the problem that the transport pockets are to be brought to the loading position in the correct alignment, in order to be able to efficiently carry out the filling. The transport pockets should be led onto the loading position in a correctly aligned manner, even for a manual filling of the transport pockets, thus by hand.

Transport pockets can hence be equipped with several receiving compartments which can be located on different side walls of the transport pockets. For filling the individual receiving compartments with conveyed items, it is now necessary for the transport pocket to be brought into the correct alignment before reaching the loading position, so that the conveyed item can be inserted into the envisaged receiving compartment. If the transport pocket is conveyed to the loading position in an incorrect alignment, it is necessary to manually rotate the transport pocket into the correct position, and such delays the loading or can lead to errors on loading the transport pockets.

Different conveyed items cannot be conveyed in the same transport pockets since the volume or the weight or the nature of the conveyed items is significantly different. Thus, transport pockets with fabric pouches, so-called “soft pouches” are only suitable for some of the conveyed items given the suspended conveying of conveyed items. Other solutions for conveying need to be provided for the remainder of the items.

Generally, there is the need for advancements in this field of technology.

### DESCRIPTION OF THE INVENTION

It is an object of the invention to provide conveying units for the suspended transport of conveyed items in a conveying facility, in particular in a rail-led conveying facility, and a method, such ensuring a simple and reliable possibility for also being able to convey the most varied of items by way of these conveying units.

Another object of the invention is to provide a corresponding conveying facility with these conveying units.

These and other objects are achieved by a conveying facility and method, according to the invention and according to the independent claims. Further embodiments and further developments are specified in the dependent claims.

According to the invention, the conveying units described hereinafter are applied for the suspended transport of conveyed items in a conveying facility, in particular in a rail-led conveying facility. The conveying units each comprise a conveying element, in particular a runner vehicle, with an attached carrier hook, and further comprise a transport element which is designed as a transport pocket and which is provided with a frame structure. A suspension hook is attached to the frame carrier. The suspension hook is mounted in the carrier hook of the conveying element in a suspended manner.

The transport pockets in the conveying direction each comprise a leading and a trailing pocket wall which are connected to one another via a pocket base section, by which means a receiving space is formed, in which the conveyed items can be conveyed.

According to the invention, the transport elements of at least two conveying units of the conveying facility according to the invention are formed as differently designed transport pockets. The differently designed transport pockets are therefore operated in a common conveying facility. The conveying facility can be operated with two, three, four or more than four types of conveying units each with differently designed transport elements, in particular with differently designed transport pockets.

Two types of conveying units with differently designed transport pockets are hereinafter denoted as the first and second conveying units. The conveying facility thus comprises in particular a plurality of at least first and second conveying units.

For unloading the conveyed items, the differently designed transport pockets are each fed to a pocket-specific unloading device and unloaded. The conveying facility thus comprises in particular one and very particularly several first unloading devices for unloading first conveying units. The conveying facility furthermore comprises in particular at least one and very particularly several second unloading devices for unloading second conveying units.

The unloading devices in particular are to permit an automatic unloading of the conveying units. For this, the unloading devices are controlled in particular via a control device.

In an advantageous embodiments type, the conveying unit is provided with a conveying or transport pocket which comprises a frame structure which is formed e.g. from a wire material. The transport pocket of the first as well as of the second conveying unit can therefore comprise such a frame structure.

In particular, the frame structure is designed to bring the transport pocket from a closure position into an open position and vice versa by way of moving the frame structure. The frame structure in the open position of the transport pocket in particular forms an upper pocket opening. In the closure position, the transport pocket in particular is closed in a compact manner by way of bringing together the leading and the trailing pocket wall. In the open position, the transport pocket in particular by way of bringing the leading and trailing pocket apart forms a receiving compartment for a conveyed item as well as an upper pocket opening.

According to a further development, the at least two conveying units with differently designed transport pockets which are operated in a common conveying facility, for loading with conveyed items can each be fed to a pocket-specific loading device for loading.

The conveying facility according to this further development thus comprises at least one or several first loading devices for loading first conveying units with conveyed items. Furthermore, the conveying facility comprises at least one or several second loading devices for loading second conveying units with conveyed items.

In particular, the loading devices are to permit an automatic loading of the conveying units with conveyed items. For this, the loading devices in particular are controlled via a control device.

According to an embodiment variant, the transport pocket of the first conveying unit comprises a leading or trailing, in particular a leading and trailing pocket wall of a flexurally rigid or bending-resistant material.

According to a further development, the leading and/or trailing pocket wall of the first conveying unit comprises a pocket wall material which consists of a plastic material or a hollow chamber material or of a composite material or of a multi-layer material or of a metal.

According to this embodiment variant, the transport pocket of the second conveying unit comprises a leading or trailing, in particular a leading and trailing pocket wall of a supple material.

According to a further development, the leading and/or the trailing pocket wall of the second conveying unit comprises a pocket wall material which consist of a fabric, a non-woven, felt, a foil material, a rubber or a silicone rubber.

The conveying element of the conveying unit advantageously comprises identification means, in particular on the runner vehicle.

In a further development, the transport pockets of the conveying units are provided with differently designed identification means.

In a further development of the conveying units, the differently designed transport pockets have different receiving volumes for conveyed items.

Advantageously, the transport elements of the conveying units comprise vertical rotation axes, about which the differently designed transport pockets are rotatable. The rotation axis in particular lies in the middle longitudinal axis of the conveying unit.

According to the invention, the conveying units with the differently designed transport pockets are operated in a common conveying facility.

According to a further development, the conveying units with differently designed empty transport pockets are fed to different empty pocket buffers.

The conveying facility according to this further development therefore comprises at least one first empty pocket buffer for the (intermediate) storing of empty, first conveying units. Furthermore, the conveying facility in particular comprises at least one second empty pocket buffer for the (intermediate) storing of second conveying units.

The conveying facility according to the invention for the suspended transport of conveyed items along conveying rails, in particular a rail-led conveying facility as mentioned comprises at least two conveying units with differently designed transport pockets.

According to a further development, in the conveying facility the differently designed transport pockets can be fed each to a pocket-specific loading device for loading with conveyed items.

Furthermore, in the conveying facility the differently designed transport pockets can each be fed to a pocket-specific unloading device for unloading the conveyed items.

In an advantageous embodiment, the conveying facility or the at least one unloading device is configured such that the unloading or emptying of the transport pockets is effected to the bottom through the opened pocket base or pocket base section.

The at least first or second or the first and second unloading device can accordingly be designed for the unloading of the respective conveying units through the pocket base or pocket base section.

If the transport pocket is a soft pouch whose receiving compartment is formed by a sheet-like material web, then this can be designed in a manner in which it can be emptied to the bottom. For this, one can e.g. envisage the one end of the sheet-like material web being arranged in a manner releasable from the frame structure. For this, e.g. a carrier loop via which the sheet-like material web is fastened to the frame structure can be designed in a manner in which it is removable from the frame structure. Thus the carrier loop e.g. via Velcro connection or popper button connection can be reversibly opened and closed. Alternatively, the sheet-like material web e.g. via a carrier loop can be fastened to a carrier rod which can be removed from the frame structure. In this manner, the material web can pivot away amid the release of a base-side unloading opening. The carrier rod can be hung e.g. in the frame structure.

If the transport pocket is a “hard pouch” then this can comprise a closable pocket base flap which releases a base-side unloading opening.

In a further development, the conveying facility is provided with a plurality of switchable points. In particular, the points can be switched via the mentioned control device.

In particular, points can serve for bringing together first and second conveying units which are conveyed separately along different conveying rails and are with differently designed transport pockets, onto a common conveying rail and conveying them (further) together. Furthermore, points can serve for leading first and second conveying units which are conveyed together on a conveying rail and are with differently designed transport pockets onto different conveying rails in order to convey these separately from one another.

The conveying elements are led to the points during the conveying of the conveyed items over the runner rails, so that the conveyed items can be led through the conveying facility with the help of the switchable points, in order to be able to reach their destination.

According to a further development, the frame structure is formed from a bent wire material.

In particular, the frame structure consists of an open or closed frame or comprises such. The frame in the open position of the transport pocket in particular forms an upper pocket opening.

The frame structure in particular also has the function of a carrier mount or carrier frame, to which in particular at least one pocket wall is fastened. The pocket wall is thus carried by the carrier mount or carrier frame.

In a further development, the differently designed transport pockets are connected to the transport element via the frame structure.

The suspension hook can be a part, in particular an integral part of the frame structure. The suspension hook can be an open or closed hook. A closed hook can comprise e.g. an eyelet which is to say an annular or loop-like body.

Preferably, the frame structure comprises a suspension hook in the form of a suspension eyelet.

According to a further development of the invention, the at least two conveying units comprise the same, in particular the identical suspension hooks.

In a further development, the in particular flexible transport pocket wall material of the transport pocket or the leading and/or trailing pocket wall of the second conveying unit consists of a fabric, a non-woven, a foil material, a rubber or a silicone rubber. The flexible, in particular supple material of the transport pocket wall is brought into shape or supported, by way of a frame such as a wire frame, as part of the frame structure.

In a further development, the transport pocket wall material of the transport pocket or of the leading and/or trailing pocket wall of the first conveying unit consists of a plastic material or a hollow chamber material or a composite material or a multi-layer material or a metal. The parts of the transport pocket walls, such as leading and/or trailing pocket wall can be connected to one another via movable elements, e.g. in the form of hinges or hooks. The frame structure can form at least a part of these movable elements.

In a further development, the conveying unit comprises an identification means, in particular on the runner vehicle.

In a further development, the differently designed transport pockets each comprise different identification means.

In a further development, the differently designed transport pockets have different receiving volumes for conveyed items.

In a further development, the differently designed transport pockets have a vertical rotation axis about which the transport pockets can be rotated.

In a further development, the differently designed transport pockets have a vertical rotation axis about which the transport pockets can each be rotated to the left and right by 90° (angle degrees).

In a further embodiment, the transport pockets considered in the conveying direction can be rotated to the right, in order to be loaded. In a further development, the transport pockets considered in the conveying direction can be rotated to the left, in order be loaded.

In a preferred embodiment of the invention, the transport pockets are pivotably fastened to the carrier hook of the runner vehicle for example via their frame structure.

In a further embodiment of the invention, the transport pockets are provided with a pivotable frame which is pivoted open for filling the transport pockets and in particular for opening the transport pockets. This frame in particular is part of the frame structure or forms this.

In a preferred embodiment of the invention, the one of the differently designed transport pockets of the first conveying unit consists of two shape-stable plates which serve as a leading and trailing pocket wall. In particular, these are pivotably connected to one another via a pivot hinge on the pocket base.

In a preferred embodiment of the invention, the runner vehicle and/or the transport pockets are provided with identification means so that they can be unambiguously indentified by way of at least one detection device in the conveying facility.

In a further development, the conveying facility for the suspended transport of conveyed items along conveying rails, in particular a rail-led conveying facility comprises at least one buffer store or intermediate buffer store. The intermediate buffer store serves for the intermediate storage of filled conveying units.

In a further development, the conveying facility for the suspended transport of conveyed items along conveying rails, in particular a rail led conveying facility comprises an empty pocket buffer for each of the differently designed transport pockets.

The conveying units for the suspended transport of transport elements, as mentioned in a conveying system, in particular in a rail-led conveying facility, are provided with a carrier hook which is attached to the conveying element, in particular to a runner vehicle. The transport element in turn is provided with a suspension hook, wherein the suspension hook is mounted in the carrier hook in a suspended manner.

The carrier hook can be an open or closed hook. A closed hook can be present e.g. as an eyelet which is to say an annular or loop-like body.

According to a further development of the invention, the at least two conveying units comprise the same, in particular identical carrier hooks.

In particular, the carrier hook is designed in a manner such that the suspension hook can assume at least three stable positions in the carrier hook.

Hereby, the suspension hook in a first stable position is rotated about an angle with respect to the suspension hook in a second stable position, i.e. in relation to a second stable position of the suspension hook. Furthermore, the suspension hook in the first stable position is rotated with respect to the suspension hook in a third stable position, i.e. in relation to the third stable position of the suspension hook, about an angle which is different than that in the second stable position.

In the first stable position, the transport element is situated in particular in a conveying position. In the second stable position, the transport element in particular is situated in a loading or unloading position. In the third stable position, the transport element in particular is situated in a loading or unloading position.

“Stable position” in particular means that the suspension hook or the conveying element with the suspension hook remains in its position or rotation position on the carrier hook in an idle position. “Idle position” in particular means that the associated conveying unit is not situated in a conveying movement. This can be the case e.g. at a loading or unloading station.

The suspension hook remaining in the “stable position” can be effected without outside intervention. In particular, this is the case at the first stable position.

The suspension hook remaining in the “stable position” can also be effected by a stop element which from the outside acts upon the suspension hook or the transport element in the stable position. The stop element e.g. in a stop position in which the transport element or the suspension hook hits or abuts upon the stop element, prevents a pivoting of the transport element from the second or third stable position back into the first stable position.

A further advantageous embodiment of the conveying unit is effected by way of the suspension hook being able to be brought to and fro between the first stable position and the second stable position and the third stable position, wherein the suspension hook lies constantly on the carrier hook.

This means that the suspension hook can be brought to and fro between the first stable position and the second stable position as well as between the first stable position and the third stable position in a manner such that the suspension hook lies constantly on the carrier hook.

The conveying unit in particular comprises a transport element with a suspension hook, wherein the suspension hook by way of rotating the transport element about a vertical of the conveying direction can be brought or moved to and fro between the first stable position and the second stable position and the third stable position on the carrier hook. The rotation angle in particular is 90° (angle degrees).

According to a further development of the conveying unit, the carrier hook forms a first rest location, a second rest location and a third rest location for the suspension hook. The suspension hook in the first stable position lies on the first rest location, in the second stable position on the second rest location, and in the third stable position on the third rest location.

A connection segment e.g. in the form of an arm section is arranged between the first rest location and the second rest location as well as between the first rest location and the third rest location, on which connection segment the suspension hook can be brought to and fro between the first stable position, the second stable position and the third stable position in a sliding manner.

The first, second and third rest locations on the carrier hook in particular have spatial orientations or arrangements which are different to one another. According to a further development, the first rest location in a projection of the rest location in a plane perpendicular to the conveying direction in particular is arranged between the second and third rest location. The first rest location in particular is arranged in a manner leading the second and third rest location in the conveying direction.

According to a further development, in the certain first spatial arrangement of the first rest location of the carrier hook, the first position in particular corresponds to a minimum of the potential energy of the transport element which is mounted in a suspended manner.

The suspension hook in the first stable position in particular has a lower or the lowest potential energy compared to the second and third stable position.

Thus, the first rest location and herewith also the suspension hook in the first stable position in particular lies at a lower level along a horizontal conveying path considered in the direction of gravity in comparison to the second and third rest location which is to say or the second and third stable position.

The first, second and third rest location in particular are formed by rest surfaces. The first, second and third rest location in a horizontal position of the conveying element can be formed by a horizontally aligned rest surface or by a recess or trough on the carrier hook.

The axis of the recess or the trough at the first rest location in particular runs parallel to the conveying direction and at the second and third rest location in particular transversely or perpendicularly to the conveying direction.

The second conveying unit according to the invention thus in particular comprises a transport element with a first transport pocket which forms a carrier pouch as a receiving compartment for conveyed items.

The second conveying unit according to the invention thus in particular comprises a transport element with a second transport pocket which forms a joint pocket as a receiving compartment for conveyed items.

According to a further variant, one of the at least two conveying units of the conveying facility can also comprise a transport element which is designed as a transport mount or transport bag.

A transport pocket, e.g. of a second conveying unit, with a carrier pouch is characterised in that the transport pocket comprises a frame structure on which the ends of a fabric web are fastened, said ends forming a carrier loop. Herein, the carrier loop forms the leading and trailing pocket wall. The transport pocket can be provided with a flexible, such as fabric-like or net-like side walls and thus form a transport pocket with a carrier pouch.

A transport pocket, e.g. of a first conveying unit, designed as a joint pocket, in particular is characterised in that the transport pocket comprises firm or flexurally rigid walls, in particular leading and trailing pocket walls, which are connected to one another in n articulated manner. It can be provided with flexible, such as fabric-like or net-like side walls and thus form a shape-stable transport pocket.

A soft pouch consists of flexible, supple material such as for example fabric material and thus a supple transport pocket can also be denoted as a soft pouch. In particular, the material is sheet-like.

A conveying unit such as first conveying unit, as a transport element comprises a transport pocket with at least two pocket walls such as a leading and trailing pocket wall, wherein this transport pocket is provided with shape-stable, flexurally rigid pocket walls. The pockets walls can at least partly consist of a hollow chamber plate. The pocket walls in particular are flexurally stiff or rigid.

A transport pocket which consists of a shape-stable, firm material such as plastic can also be denoted as a “hard pouch”.

Conveying units with transport elements consisting of a soft pouch or a hard pouch, applied in a common conveying facility have the advantage that the soft pouch can be used for special conveyed items which are suitable for a soft pouch, and the hard pouch can be used for special conveyed items which are suitable for a hard pouch or only for a hard pouch. Thus, in the same (suspended) conveying facility it is possible to convey more varied types of conveyed items. By way of this, the capacity of the suspended conveying facility can be significantly expanded.

The at least two conveying units according to the invention or types of conveying units according to the invention thus comprise transport elements, wherein the transport elements can be different types or designs of transport pockets.

The at least two conveying units in particular comprise transport pockets, wherein these transport pockets each comprise a rear pocket wall such as rear wall, and a front pocket wall such as front wall, which are flexibly connected to one another via a pocket base section in a manner such that they can be brought between a first state, e.g. an open position in which they form a receiving compartment which is open to the top and can be filled from above, and a second state e.g. closure position in which lying tightly next to one another, they form an in particular folded-together transport pocket. These states in particular can be achieved by way of moving to and fro, in particular a frame structure, as described above.

The rear wall is characterised in particular in that this to the top merges into a carrier section on which the suspension hook is arranged. The carrier section of a hard pouch in particular can be designed as an extension of the rear wall to the top.

The transport pockets can be conveyed in the conveying direction with a leading rear wall and a trailing front wall or with a leading front wall and a trailing rear wall.

A rotation device which is arranged on the conveying rail in a conveying facility, for rotating the transport elements of conveying units rotates the transport elements about their vertical rotation axis in particular between the first, second and third stable position of the suspension hook on the carrier hook.

The rotation device in particular is characterised in that activatable active elements can be brought into the path or conveying corridor of the transport elements such that the transport elements in the conveying direction rotate to the right or to the left about their vertical axis before the transport pockets e.g. reach a loading position in a loading station which comprises a loading device or an unloading position in an unloading station which comprises an unloading device.

The transport elements herein during their conveying in the conveying direction hit the active elements which project into the conveying corridor, by which means the rotation is activated. The active elements can be rods or rollers.

A “conveying corridor” in particular is to be understood as a conveying space which leads along the conveying direction and through which the conveying units or conveying elements of the conveying units move.

The rotation device in particular is accordingly arranged in front of a loading or unloading device in the conveying direction or is a part of this.

A loading device can be provided for loading transport elements with conveyed items, wherein the loading with the conveyed items is effected transversely to the conveying direction of the conveying element, and wherein the transport elements are rotated about their vertical axis by the rotation device into the alignment which is envisaged for loading, before the loading in the loading station.

An unloading device can be provided for unloading the transport elements, wherein the unloading is effected transversely to the conveying direction of the conveying element and wherein the transport elements are rotated about their vertical axis by the rotation device into the alignment which is envisaged for unloading, before the unloading in the unloading station.

A conveying facility according to the invention is designed for the guided, suspended transport of conveying units which are provided with transport elements in the form of transport pockets which are led along conveying rail, wherein the rail-led conveying facility is provided with at least two differently designed (first and second) conveying units.

The transport pocket for conveying units, in the upper part of the carrier frame can comprise a suspension hook which in turn is designed as an eyelet, wherein this eyelet of the suspension hook is rotated at right angles with respect to the carrier frame of the transport pocket which is to say the plane of the eyelet is aligned perpendicularly to the plane of the carrier frame.

The suspension hook can also be attached to the carrier frame in a movable manner. In this case the carrier frame and the suspension hook are two separate parts which in particular can be rotated or pivoted to one another.

The control device controls the complete operation of the devices, in particular of the conveying facility. Thus, a control centre with the control device can be additionally present in the conveying facility, said control centre being designed to control the flow of items within the conveying facility.

The conveying facility can comprise at least on stop and release device for stopping conveying units along the conveying path and for the release of the conveying units for the individual further transport e.g. to a loading or unloading device. The stop and release device can be arranged upstream of a loading or unloading station or upstream of a rotation device which is assigned to the loading or unloading station.

The control device controls the stop and release device in order on the one hand to be able to stop the conveying units, but also on the other hand to be able to release the conveying units individually or in groups, for the conveying.

The invention is described for a conveying facility with an outer runner as runner vehicle. Of course, the conveying facility according to the invention is also suitable for inner runners as runner vehicles of the conveying facility, wherewith this invention also includes an inner runner facility.

The conveying units can comprise different transport pockets for conveyed items, in particular transport pockets which are designed in various manners for different types of conveyed items. An equal type of transport element can comprise different transport pockets which can each receive different item types.

The receiving spaces or receiving places of the transport pockets can be closable. The conveyed item can also be conveyed held in a carrying manner.

The conveyed item however can also be held in a clamping manner during the conveying. The conveyed item during the conveying can be conveyed held in a clamped manner between the front wall and the rear wall.

Considered in the conveying direction, transport pockets can either be rotated to the right or to the left with the help of the rotation device. Different types of transport pockets can be filled with conveyed items by way of different loading devices. In particular, different types of receiving compartments can be loaded with conveyed items.

The frame structure can be of one part or constructed in a multi-part manner. The frame structure as mentioned can be designed as a carrier frame of the transport pocket. The carrier frame is a synonym for the frame structure which comprises a frame-like structure which on the one hand can be hung onto the carrier hook and on the other hand forms a frame on which at least one pocket wall such as the carrier loop of the pocket pouch is fastened.

According to a further development, the transport pockets of a further type of conveying units can also be transport baskets which transport conveyed items. The transport baskets thus as a rule comprise deposition locations at which the conveyed items can be deposited. These transport baskets can also be rotated and aligned for the loading or for unloading.

Suspended conveying facilities can be part-facilities of conveying facilities. Hence conveying facilities or conveying systems are superordinate facilities which can also encompass lying conveyors, warehouses, pallet warehouses, high bay warehouses and also warehouse management computers.

As mentioned, a conveying unit consists of a conveying element, in particular in the form of a runner vehicle, and at least one transport element in the form of a transport pocket which can receive conveyed items, such as individual items, for transport.

According to a further development of the invention, the at least two conveying units or types of conveying units have the same, in particular identical conveying elements such as runner vehicles.

Individual items can be goods, articles, consumer goods, individual parts but also smaller containers. Individual items differ significantly in their size, their inner nature and their weight and their sensitivity to pressure and their effort in handling.

The transport pockets can receive individual items at loading devices in an automated manner and deliver them in an automated manner at unloading devices. The filled transport pockets in particular are conveyed automatically from the loading devices to a sorting device. After the sorting, the transport pockets which belong to an order are conveyed towards the delivery destination. The transport pockets are led through the conveying facility in a manner controlled by points, in order to achieve their predefined delivery destination. The points are controlled by way of a superordinate control device such that the transport pocket reaches its delivery destination. The delivery destination in particular is a delivery or unloading station.

An unloading device for soft, supple transport pockets which are also denoted as soft pouches can be present at the delivery destination or at the unloading station. Or an unloading device for firm, flexurally rigid transport pockets which are also denoted as hard pouches can be present at the delivery destination or at the unloading station. The transport pockets are unloaded at the unloading devices, wherein the conveyed item leaves the transport pocket.

However, two in particular different unloading devices can also be present at the delivery destination or at the unloading station, one for soft, supple transport pockets such as soft pouches, and one for firm, flexurally rigid transport pockets such as hard pouches, so that both transport pocket types can be unloaded at a delivery destination or at delivery or unloading station.

A significant aspect of the invention relates to a conveying facility which comprises at least one suspended conveying facility which applies at least one conveying unit for conveying conveyed items, as is described above. The conveying facility can furthermore comprise at least one conveying section, buffers for empty conveying units, drive units for the conveying units, a stop device for conveying units, sorting systems such as for example a matrix sorter, switchable points, buffer stores, loading stations, unloading stations, measuring stations for conveying units or for conveying or transport pockets, revolving conveyors, palletising devices, dispatches, dispatch locations, identification devices and control devices.

The invention also relates to a method for operating an aforementioned conveying facility. The method is characterised by the simultaneous transporting or conveying of at least two conveying units with differently designed transport pockets along a common conveying path of the conveying facility.

In a further development, the method relates to the feeding of the at least two conveying units to different, pocket-specific empty pocket buffers.

In a further development, the method relates to the loading of the at least two conveying units at different, pocket-specific loading devices.

In a further development, the method relates to the unloading of the at least two conveying units at different, pocket-specific unloading devices.

According to a further development of the method, first and second conveying units which are conveyed separately and are with differently designed transport pockets, after the loading at the loading devices are brought together onto a common conveying rail via points and are conveyed further together.

According to a further development of the method, first and second conveying units which are conveyed together on a conveying rail and are with differently designed transport pockets are led onto different conveying rails by way of switched points and are conveyed separately from one another to the unloading devices or to the delivery regions which contain the unloading devices according to conveying unit type. I.e. the first conveying units subsequently to the points in particular are conveyed further on a first conveying rail and the second conveying units are conveyed further on a second conveying rail.

The subject-matter of the invention is hereinafter explained in more detail by way of embodiment examples which are represented in the accompanying figures.

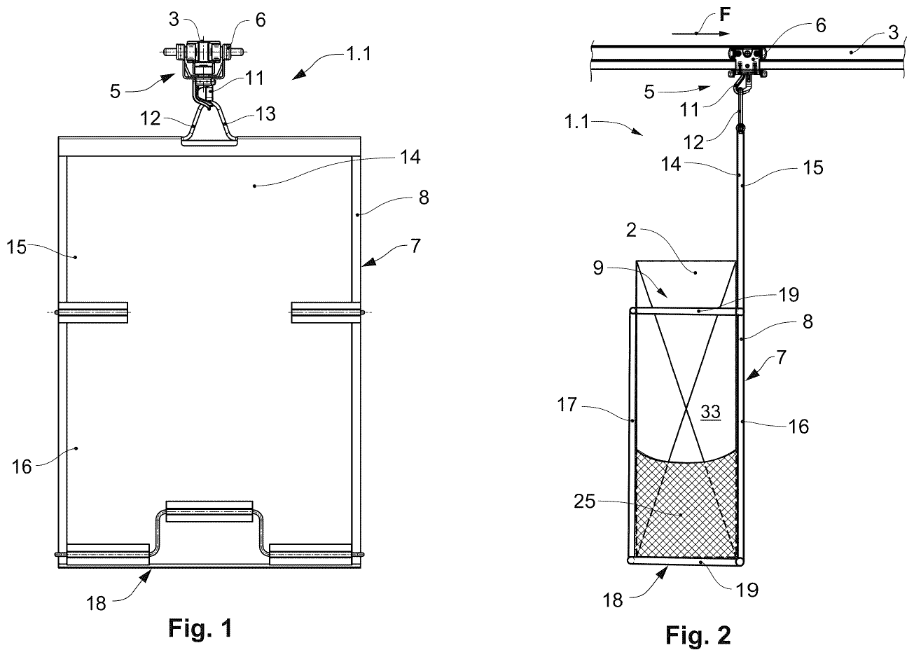

FIG. 1 shows a conveying unit in a plan view onto the rear wall, consisting of a runner vehicle and a transport element in the form of a transport pocket with flexurally rigid side walls.

FIG. 2 shows the same conveying unit as in FIG. 1 in a lateral view, said conveying unit being applied in a suspended conveying facility and consisting of a runner vehicle and a transport element in the form of a transport pocket with flexurally rigid side walls.

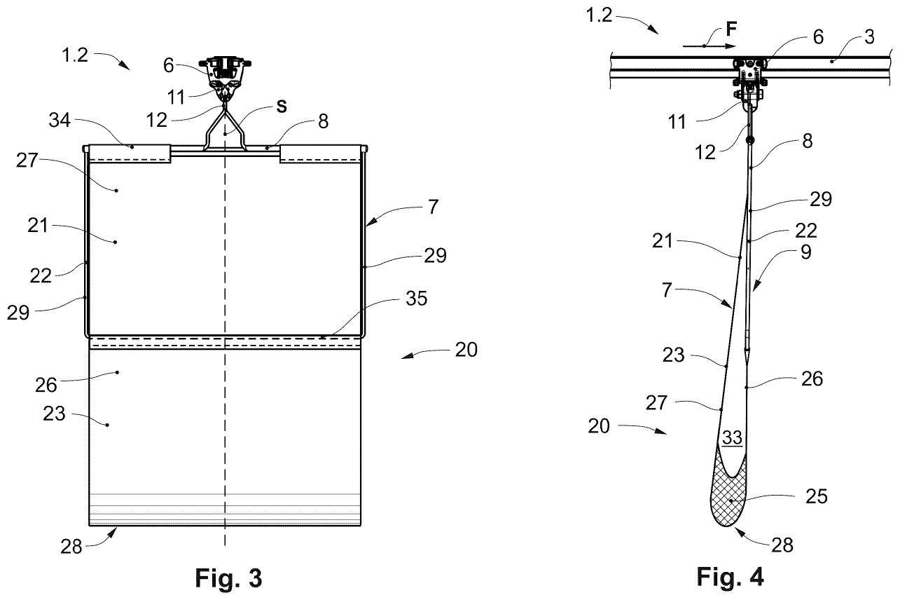

FIG. 3 shows a conveying unit in a plan view, consisting of a runner vehicle and a transport element in the form of a transport pocket with supple side walls.

FIG. 4 shows the same conveying unit as in FIG. 3, in a lateral view, said conveying unit being applied in a suspended conveying facility and consisting of a runner vehicle and a transport element in the form of a transport pocket with supple side walls.

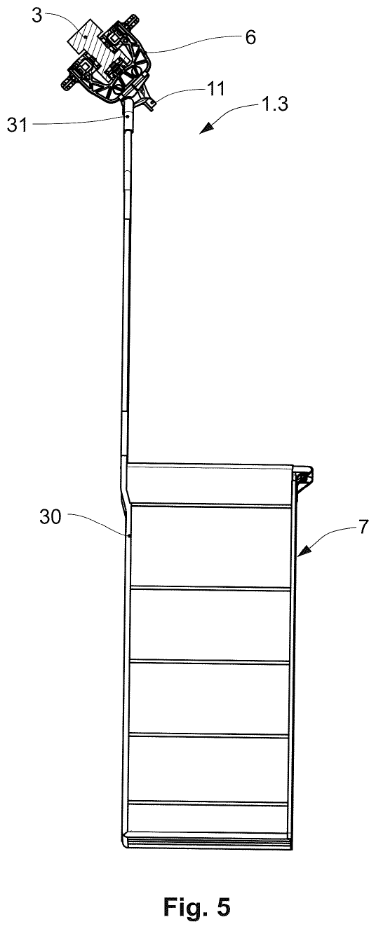

FIG. 5 shows a further conveying unit in an isometric view, with a transport element in the form of a carrier mount or carrier frame.

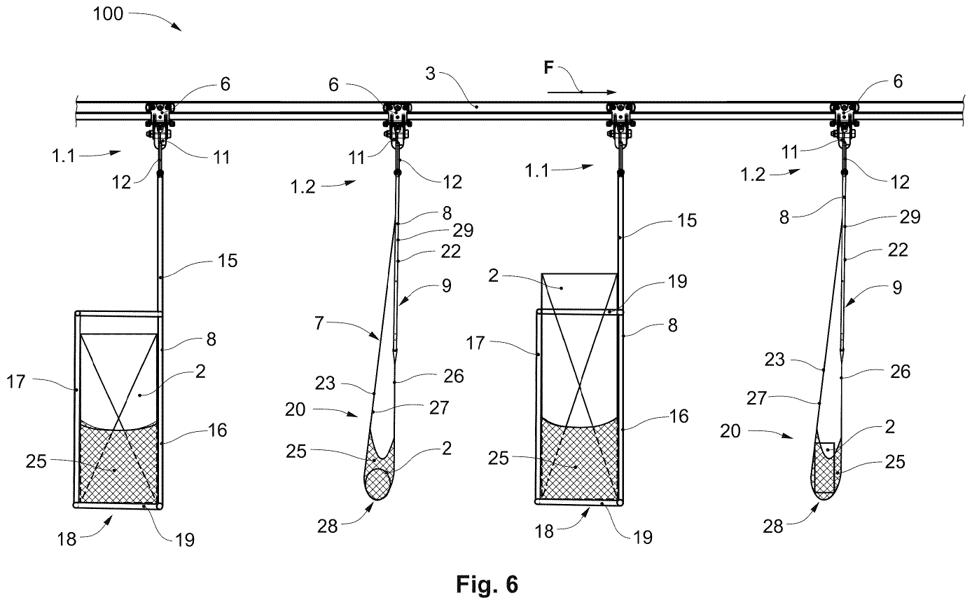

FIG. 6 shows a conveying section in a lateral view, in which section different types of conveying units are applied, such being those with flexurally rigid conveying or transport pockets and those with supple conveying or transport pockets.

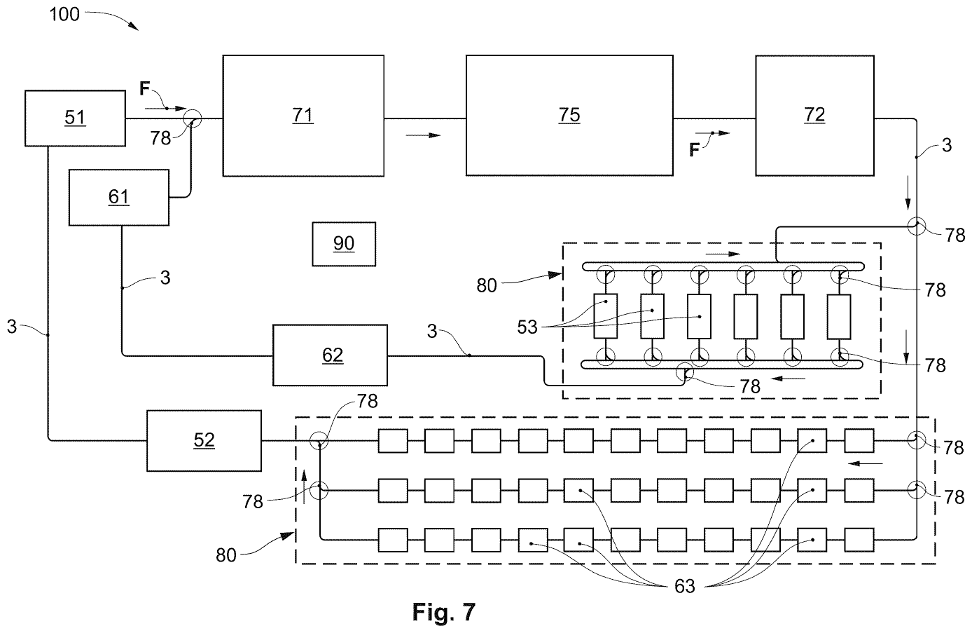

FIG. 7 schematically shows a conveying facility in which the conveying units are applied for the conveying of conveyed items.

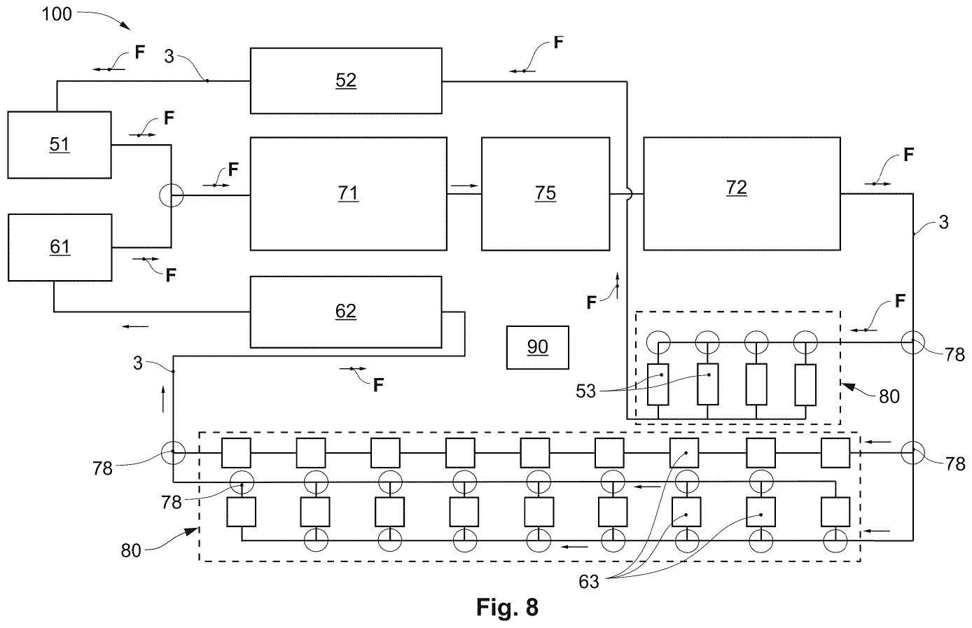

FIG. 8 likewise shows a schematic conveying facility with a different design, in which the conveying units are applied for the conveying of conveyed items.

The embodiment examples which are described hereinafter are merely to be understood as exemplary of the subject-matter of the invention and have no limiting effect. Basically, in the figures the same parts are provided with the same reference numerals.

A first possible embodiment of a conveying unit 1.1 according to the invention is represented in FIG. 1 and FIG. 2. A transport element 7 in the form of a transport pocket 15 has a suspension hook 12 which hung into a carrier hook 11 of a conveying element 5. The mentioned components form the conveying unit 1.1. The conveying unit 1.1 as is explained further below is a so-called hard pouch.

The conveying element 5 in the shown example is a runner vehicle 6 of a suspended conveying facility 100, analogously to the facility as is disclosed for example in WO 2016/030275 A1 of the applicant. For a better understanding, the runner vehicle 6 in FIG. 2 is represented on a runner rail 3 of a conveying facility 100 where it moves in an envisaged conveying direction F. The transport pocket 15 comprises a carrier mount or frame structure 8, a rear wall 16, a pocket base section 18 as well as a front wall 17 which are pivotably connected to one another at the abutting edges. The rear wall 16, front wall 17 and the pocket base section 18 are designed in a stable and flexurally rigid manner and can be manufactured for example of a suitable plastic material such as a hollow chamber plate. The flexibly designed side wall 25 connects the rear wall 16, the front wall 17 and the pocket base section 18 in a lower region, so that the transport pocket 15 forms a container with a receiving space 33. The container forms an upper pocket opening 9 through which the at least one conveyed item 2 can be loaded. In the shown example, the side walls 25 are manufactured from a finely meshed net. The use of a flexible, in particular sheet-like textile material is also possible. The side walls 25 are designed such that on folding together the transport pocket 15 they can likewise be folded together as described below.

According to FIGS. 2 and 6, considered in the conveying direction F the rear wall 16 of the transport pocket 15 forms the leading pocket wall and the front wall 17 the trailing pocket wall. The transport pocket 15 however can also be arranged in a manner rotated by 180°, so that the rear wall 16 forms the trailing pocket wall and the front wall 17 the leading pocket wall.

Two pivotable spacers 19 are arranged at each side between the rear wall 16 and the front wall 17 and these are connected to one another into an in particular closed frame such as wire frame or are part of a frame or wire frame. The spacers 19 in the opened state of the transport pocket 1.1 distance the rear wall 16 from the front wall 17 in an upper region. The spacers 19 are arranged essentially parallel to the pocket base section 18 and are equally long as the pocket base section 18, so that the rear wall 16 lies essentially parallel to the front wall 17 and herewith the front wall 17, the spacer 19, the rear wall 16 and the pocket base section 18 accordingly form a parallelogram. In the folded-open state, the rear wall 16, the front wall 17 and the pocket base section 18 form a receiving space 33 for conveyed items. In the non-loaded state, the weight of the front wall 17 and the pocket base section 18 allows the front wall 17 to pivot to the bottom so that the transport pocket 15 goes into a second state in which the front wall 17 and the rear wall 16 lie close to one another, in particular bear on one another. In this configuration, the transport pocket 15 can be kept in the conveying facility 100 in a space-saving manner by way of the conveying units 1.1 being rowed successively on a runner rail 3 in a flush manner.

By way of lifting the front wall 17 and/or the pocket base section 18 with respect to the rear wall 16, the transport pocket 15 can be brought from the second folded-together state into a first, unfolded state, as is shown in FIG. 1 and FIG. 2. The spacer 19 or the frame or wire frame which comprises the spacer 19 forms the upwardly directed pocket opening 9. The upwardly directed pocket opening 9 of the transport pocket 15 reaches the maximum size given the completely unfolded or folded-open transport pocket 1.1.

In the shown embodiment example, a conveyed item 2 represented schematically by a cuboid object is arranged in the transport pocket 15.

The rear wall 16 at its upper end is extended into a carrier section 15 beyond the spacers 19 or pocket opening 9. The suspension hook 12 in the form of a bow such as wire bow is connected to the rear wall 16 and to the carrier section 14 of this, at the upper end of the rear wall 16 and of the carrier section 14 respectively. The bow of the suspension hook 12 defines an orientation plane of the suspension hook 12 and herewith of the complete transport pocket 15. The bow of the suspension hook 12 in particular lies in the plane of the rear wall 16.

The carrier hook 11 is attached to a lower end of the runner vehicle 6 which is away from the runner rail 3. It can be manufactured of metal or of a suitable polymer material, for example of a glass-fibre reinforced thermoplastic material. The carrier hook 11 comprises a bow which is closed in the assembled state and has two mounting segments. Given a horizontal position of the runner vehicle, the first mounting segment corresponds to the lowest point of a tab or of an arm section of the carrier hook 11. Represented in FIG. 1, the suspension hook 12 is situated in a first stable position at which the suspension hook is mounted in the first mounting segment with a minimum of potential energy. In this stable position the suspension hook 12 is aligned in a plane transverse to the conveying direction F.

In this context, what is meant by the term “transverse” is every orientation of the suspension hook plane at which the suspension hook 12 does not lie in a plane essentially parallel to the conveying direction F. In the shown example, the suspension hook 12 just as the rear wall 16 lies in a plane perpendicular to the conveying direction F. However, other angles at which the transport pockets 15 in the empty or filled state can be mounted in a successively rowed and space-saving manner on the runner rail would also be possible.

A second conveying unit 1.2 with an alternative embodiment of a transport element 7 is shown in FIG. 3 and FIG. 4. The transport element 7 is likewise present in the form of a transport pocket 21 and this however differs significantly from the transport pocket 15 of FIG. 1. The transport element 7 is a so-called soft pouch 21. The soft pouch 21 is a flexible transport element 7 in the form of a carrier loop 20 which is suspended on a carrier mount or a fame structure 8. The carrier mount or the frame structure 8 comprises a carrier frame 22. The second transport pocket 21 thus consists of a carrier frame 22 and a loop 23 which is manufactured of a fabric. A suspension hook 12 which is hung in the carrier hook 11 of a runner vehicle 6 is formed at the upper end of the carrier frame 22. The loop 23 which is present as a fabric web is fastened to an upper shoulder 34 of the carrier frame 22 at the height of the suspension hook 12. The upper shoulder 34 is formed e.g. by a transverse rod or transverse strut, on which in particular the suspension hook 12 is also attached or shaped out. The loop 23 runs downwards from the upper shoulder 34 and forms the rear wall 27 of the flexible transport element 7. The rear wall 27 ends at the pocket base section 28 which is likewise formed by a loop 23, and from where the loop or fabric web 23 leads to a lower shoulder 35 of the carrier frame 22. The lower shoulder 35 is formed e.g. by a transverse rod or transverse strut. The loop or fabric web 23 is fastened to the carrier frame 22 via the lower shoulder 35 and thus forms a front wall 26 between the pocket base section 28 and the shoulder 35. The carrier frame 22 which forms the pocket opening 9 is therefore arranged above the front wall 26. The carrier frame 22 furthermore also comprises two spacers 29 which are arranged on each side between the front wall 26 and the rear wall 27. The spacers 29 together with the upper and lower shoulder 34, 35 are connected to one another into an in particular closed bow, such as wire bow. This forms the pocket opening 9. In the opened state of the transport pocket 1.2, the spacers 29 distance the front wall 26 to the rear wall 27 in an upper region.

The soft pouch 21 is provided laterally with flexible side walls 25, in particular of a flexible net fabric. These connect the front wall 26 and the rear wall 27 to one another in a lower pocket region.

In the folded-open state of the transport pocket, the front wall 26, the rear wall 27, the side walls 25 and the pocket base section 28 form a receiving space 33 for conveyed items.

A pivoting of the carrier frame 22 in the conveying direction F leads to an opening of the soft pouch 21 and releases the pocket opening 9 for the receiving space 33 of the soft, supple transport pocket 21.

FIG. 5 shows a third embodiment of a conveying unit 1.3 with a transport element 7 in the form of a carrier mount 30. Such a transport element 7 has the advantage that the conveyed items 2 are clearly visible from the outside.

In FIG. 5, the conveying element 5 in the form of the runner vehicle 6 is used for conveying the carrier mount 30 along a runner rail 3, wherein the suspension hook of the carrier mount 30 is hung into the carrier hook 11 of the runner vehicle 6. The suspension hook which in particular is an open suspension hook can assume two resting stable positions in the carrier hook 11.

A part of a conveying facility is represented in FIG. 6. Different embodiments of conveying units 1.1, 1.2 with different transport pockets 15, 21 are arranged successively in a runner rail 3. The drive is not represented. Transport pockets are particular forms of transport elements 7 since they receive conveyed items 2 in them. In this manner, the transport pockets 15, 21 provide a certain protection for the conveyed item 2. Firm, flexurally rigid transport pockets 15 or transport pockets 15 with a firm flexurally rigid front and rear wall should be used for fragile conveyed items 2. In the case of non-fragile conveyed items, so called soft pouches 21 can be applied. Soft pouches 21 have the additional advantage that they are lighter and less expensive than the firm, flexurally rigid transport pockets 15. Regarding firm, flexurally rigid transport pockets 7, one also speaks of hard pouches 15.

The soft pouches 21 are lighter and consist of a thin transport pocket wall material. By way of this, the soft pouch 21 is only suitable for the transport for non-fragile conveyed items 2. The hard pouches 15 are designed larger and comprise firm, stable transport pocket walls such as a rear and front wall 16, 17. The hard pouch 15 on account of its design with firm, flexurally rigid conveying or transport pocket walls 16, 17 is also suitable of transporting fragile conveyed items 2.

Both conveying or transport pocket types or designs require different automated delivery and unloading stations with unloading devices 53, 63 which are adapted to the respective transport pocket 15, 21 (see also FIGS. 7 and 8). This further means that the respective transport pockets 15, 21 are conveyed towards the delivery or unloading stations which are each adapted to the transport pockets 15, 21, with unloading devices 53, 63 which are adapted according to the pocket type, in the conveying facility 100, in order to unload the conveyed item 2 from the transport pocket 15, 21 there. For this reason, a multitude of switchable points 78 need to be integrated in the conveying facility 100 in order to feed the transport pockets 15, 21 to the respective delivery regions 80 for the respective transport pocket 15, 21 in a targeted manner. A delivery region 80 herein comprises a plurality of unloading devices 53, 63 of a specific type of unloading device 53, 63. The points 78 are activated or controlled by way of a superordinate control device 90 such that the transport pocket 15, 21 reaches its predefined delivery destination or the correct unloading device 53, 63 in the respective delivery region 80.

Schematic representations of conveying facilities 100 in which conveying units 1.1, 1.2 are processed are represented in FIG. 7 and FIG. 8. The conveying units 1.1, 1.2 are not shown in these figures. A first loading device 51 for soft pouches in which the supple transport pockets 21 are loaded with conveyed items 2 is to be seen in FIG. 7. The empty soft pouches come from a first empty pocket buffer 52, in which empty transport pockets 21 in the manner of a soft pouch are intermediately stored until they are demanded for loading.

Apart from a first loading device 51, a second loading device 61 for hard pouches 15 can be seen, in which second loading device the firm, flexurally rigid transport pockets 15 can be loaded with conveyed items 2. The empty hard pouches 15 come from the second empty pocket buffer 62 in which the empty transport pockets 15 in the manner of a hard pouch are intermediately stored until they are required for loading in the second loading device 61.

After the two loading devices 51 and 61, the transport pockets 15, 21 are led together onto a common conveying rail 3 via points 78 and are conveyed to an intermediate store 71. The transport pockets 15, 21 can be intermediately stored in the intermediate buffer or intermediate store 71, or the transport pockets 15, 21 can pass the intermediate store 71 when the transport pockets 15, 21 are required for processing. The intermediately stored transport pockets 15, 21 on request are transferred from the intermediate store 71 to a sorting device 75. In the sorting device 75 the individual transport pockets 15, 21 are grouped together into individual orders and then form a complete order in the manner of several transport pockets which are arranged one after the other.

The individual facility components are connected to one another by conveying rails 3 of the suspended conveying system, along which rails the conveying units 1 move in the conveying direction F. Points 78 can be present between the individual facility components and these are necessary for the targeted conveying of transport pockets 15, 21 so that the conveying units 1 can reach the different facility components. The complete facility is controlled by a superordinate control device 90 so that the conveying units 1.1, 1.2 can reach their envisaged stations The composed orders can now be intermediately stored in a further intermediate store or intermediate storage until the orders can be processed further and are conveyed to the delivery region 80. The orders which have been completely put together however can also be conveyed directly to their delivery location 80 where the transport pockets 15, 21 can be unloaded one after the other by way of the unloading devices 53 and 63. Hereby, the soft, supple transport pockets 21 are unloaded in one of the first unloading devices 53 and the firm, flexurally rigid transport pockets 15 are unloaded in one of the second unloading devices 63.

The first unloading device 53 is adapted especially for the soft pouches 21, so that the soft pouches 21 can be unloaded in an automated manner. After the unloading, the soft pouches 21 are brought into the first empty pocket buffer 52 where they wait for the next transport request.

The second unloading device 63 is adapted especially for the hard pouches 15, so that the hard pouches 15 can be unloaded in an automated manner. After the unloading, the hard pouches 15 are brought into the second empty pocket buffer 62 where they wait for the next transport request.

At the delivery or unloading stations, to which the unloading devices 53, 63 are assigned, the unloaded conveyed items 2 of an order are packaged ready for shipping and transferred to the dispatch.

FIGS. 7 and 8 differ in the arrangement of the unloading devices 53, 63. In FIG. 7 the first unloading devices 53 are all arranged in parallel and the second unloading devices 63 are all arranged in series. In FIG. 8 the second unloading devices 63 are partly arranged in parallel and partly in series.

Furthermore, a first unloading device 53 and a second unloading device 63 can also each be arranged next to one another. Thus, conveyed items 2 can be delivered from the soft pouch and conveyed items 2 from the hard pouch at a common delivery destination which is to say at a common unloading station. An unloading station can thus comprise a first as well as a second unloading device 53, 63.

The present invention is not limited in its scope to the specific embodiments which are described here. In contrast, different further modifications of the present invention result for the man skilled in the art from the description and the associated figures, additionally to the examples which are disclosed here, such further modifications likewise falling within the protective scope of the claims. Additionally, different references are cited in the description, the contents of whose disclosure is herewith incorporated in its entirely into the description by reference.

1. A conveying facility with a plurality of conveying units for the suspended transport of conveyed items, in particular a rail-led conveying facility, wherein the conveying units each comprise a conveying element, in particular a runner vehicle, with a carrier hook which is attached to this, and a transport element which is designed as a transport pocket and is equipped with a frame structure and provided with a suspension hook which is attached to the frame structure, wherein the suspension hook is mounted in the carrier hook of the conveying element in a suspended manner, wherein the transport pockets in the conveying direction each comprise a leading and a trailing pocket wall which are connected to one another via a pocket base section, by which means a receiving space is formed, in which receiving space the conveyed items can be conveyed,
wherein the transport elements of at least two conveying units are formed as differently designed transport pockets, and the conveying facility comprises pocket-specific unloading devices, so that the differently designed transport pockets of the conveying units can each be fed to a pocket-specific unloading device for unloading the conveyed items.

2. The conveying facility according to claim 1, wherein the frame structure is formed from a wire material.

3. The conveying facility according to claim 1, wherein the conveying facility comprises pocket-specific loading devices, and the differently designed transport pockets can each be fed to a pocket-specific loading device for loading with conveyed items.

4. The conveying facility according to claim 1, wherein the pocket wall material of the transport pocket of a first conveying unit, in particular of the leading and trailing pocket wall, consists of at least one flexurally rigid material, such as plastic material, hollow chamber material, composite material, multi-layer material or metal.

5. The conveying facility according to claim 1, wherein the pocket wall material of the transport pocket of a second conveying unit, in particular of the leading and trailing pocket wall, consists of flexible, in particular sheet-like material such as a fabric, a non-woven, felt, a foil material, a rubber or a silicone rubber.

6. The conveying facility according to claim 1, wherein the conveying element comprises an identification means, in particular on the runner vehicle.

7. The conveying facility according to claim 1, wherein the differently designed transport pockets of the conveying units comprise identification means.

8. The conveying facility according to claim 1, wherein the differently designed transport pockets of the conveying units have different receiving volumes or differently large receiving spaces for conveyed items.

9. The conveying facility according to claim 1, wherein the transport element of the conveying units each has a vertical axis, about which the differently designed transport pockets can be rotated.

10. The conveying facility according to claim 1, wherein the conveying facility comprises pocket-specific empty pocket buffers and the differently designed, empty transport pockets are fed to different empty pocket buffers.

11. The conveying facility according to claim 1, wherein one or more or all the following features applies/apply:
the at least two conveying units comprise the same suspension hooks;
the at least two conveying units comprise the same conveying elements such as runner vehicles;
the at least two conveying units comprise the same carrier hooks.

12. The conveying facility according to claim 1, wherein at least one further, third conveying units for the suspended transport of conveyed items, said third conveying unit comprising a conveying element, in particular a runner vehicle, with a carrier hook which is attached to the conveying element, and a transport element which is designed as a carrier mount and is with a suspension hook which is attached to the carrier mount, wherein the suspension hook is mounted in the carrier hook of the conveying element in a suspended manner.

13. The conveying facility according to claim 1, wherein the transport pockets of the at least two conveying units each comprise a pocket base section or pocket base which can be opened so that an unloading of the transport pockets can be effected to the bottom through the opened pocket base section of pocket base.

14. The conveying facility according to claim 1, wherein the conveying facility is provided with at least one, in particular with a plurality of switchable points in order to lead together first and second conveying units with differently designed transport pockets and which are conveyed separately, onto a common conveying rail and to commonly convey them and/or in order to lead first and second conveying units with differently designed transport pockets and which together are conveyed on a conveying rail, onto different conveying rails and to convey them separately from one another.

15. A method for operating a conveying facility according to claim 1, comprising the steps of:
simultaneous transporting of at least two conveying units with differently designed transport pockets along a conveying track of the conveying facility;
if necessary, feeding the at least two conveying units to different, pocket-specific empty pocket buffers,
if necessary, loading the at least two conveying units at different, pocket-specific loading devices;
if necessary, unloading the at least two conveying units at different, pocket-specific unloading devices.

16. The method according to claim 15, wherein first and second conveying units which are conveyed separately and are with differently designed transport pockets, after the loading at the loading devices are brought together onto a common conveying rail via points and together are conveyed further and/or that first and second conveying units with differently designed transport pockets and which together are conveyed on a conveying rail are led onto different conveying rails by way of points and are conveyed separately from one another to the unloading devices or to the delivery regions which comprise the unloading devices.
